(19) United States
(12) Patent Application Publication
(10) Pub. No.: US 2011/0244581 A1
(43) Pub. Date: Oct. 6, 2011

(54) BIOLOGIC FLUID ANALYSIS SYSTEM WITH SAMPLE MOTION

(75) Inventors: Igor Nikonorov, Whitestone, NY (US); Niten V. Lalpuria, Mumbai (IN); Jeremy Hill, Guilford, CT (US); John Wieners, Morrisville, PA (US); Anil S. Patil, Iselin, NJ (US); Robert Levine, Guilford, CT (US); Benjamin Ports, Hamden, CT (US); Darryn Unfricht, North Haven, CT (US)

(73) Assignee: Abbott Point of Care, Inc., Princeton, NJ (US)

(21) Appl. No.: 13/077,476

(22) Filed: Mar. 31, 2011

Related U.S. Application Data
(60) Provisional application No. 61/319,429, filed on Mar. 31, 2010.
(60) Provisional application No. 61/417,716, filed on Nov. 29, 2010.

(51) Int. Cl. G01N 21/75

(52) U.S. Cl. 436/43; 422/400

(57) ABSTRACT

An apparatus for and method of analyzing a biologic fluid sample is provided. The method includes the steps of: a) providing a sample cartridge having at least one channel for fluid sample passage; b) providing an analysis device having imaging hardware, a programmable analyzer, and a sample motion system, which sample motion system includes a bidirectional fluid actuator operable to selectively move a bolus of sample axially within the channel, and to cycle the bolus back and forth within the channel; and c) cycling the bolus of sample disposed within the channel at a predetermined frequency until constituents within the sample are substantially uniformly distributed, using the bidirectional fluid actuator.

The present application is entitled to the benefit of and incorporates by reference essential subject matter disclosed in U.S. Provisional Patent Application Ser. No. 61/319,429 filed Mar. 31, 2010 and U.S. Provisional Patent Application Ser. No. 61/417,716 filed Nov. 29, 2010.

### BACKGROUND OF THE INVENTION

1. Technical Field

The present invention relates to apparatus for biologic fluid analyses in general, and to systems for processing biologic fluid samples having suspended constituents in particular.

2. Background Information

Historically, biologic fluid samples such as whole blood, urine, cerebrospinal fluid, body cavity fluids, etc. have had their particulate or cellular contents evaluated by smearing a small undiluted amount of the fluid on a slide and evaluating that smear under a microscope. Reasonable results can be gained from such a smear, but the cell integrity, accuracy and reliability of the data depends largely on the technician's experience and technique.

In some instances, constituents within a biological fluid sample can be analyzed using impedance or optical flow cytometry. These techniques evaluate a flow of diluted fluid sample by passing the diluted flow through one or more orifices located relative to an impedance measuring device or an optical imaging device. A disadvantage of these techniques is that they require accurate dilution of the sample, and fluid flow handling apparatus.

It is known that biological fluid samples such as whole blood that are quiescently held for more than a given period of time will begin “settling out”, during which time constituents within the sample will stray from their normal distribution. If the sample is quiescently held long enough, constituents within the sample can settle out completely and stratify (e.g., in a sample of whole blood, layers of white blood cells, red blood cells, and platelets can form within a quiescent sample). As a result, analyses on the sample may be negatively affected because the constituent distribution within the sample is not a normal distribution.

To overcome the problems associated with a blood sample “settling out” within a Vacutainer® tube, it is known to repeatedly upend the Vacutainer® tube and allow gravity to mix the sample. This gravitational technique works well with a substantially filled Vacutainer® tube, but is not effective for very small volumes of blood sample residing within a vessel subject to capillary forces. The capillary forces acting on the sample are greater than the gravitational forces, thereby inhibiting the desired sample mixing.

What is needed is an apparatus and a method that provides sample mixing adequate to create a uniform distribution of constituents and reagents within the sample.

### DISCLOSURE OF THE INVENTION

According to an aspect of the present invention, a biologic fluid analysis system is provided. The system includes a sample cartridge having at least one channel that is, or is operable to be placed, in fluid communication with an analysis chamber, and an analysis device. The analysis device includes imaging hardware, a programmable analyzer, and a sample motion system. The sample motion system includes a bidirectional fluid actuator adapted to selectively move a bolus of sample axially within the channel, and to cycle the bolus back and forth within the channel in a manner that at least substantially uniformly distributes constituents within the sample.

According to another aspect of the present invention, a method of analyzing a biologic fluid sample is provided. The method includes the steps of: a) providing a sample cartridge having at least one channel for fluid sample passage; b) providing an analysis device having imaging hardware, a programmable analyzer, and a sample motion system, which sample motion system includes a bidirectional fluid actuator operable to selectively move a bolus of sample axially within the channel, and to cycle the bolus back and forth within the channel; and c) cycling the bolus of sample disposed within the channel at a predetermined frequency until constituents within the sample are substantially uniformly distributed, using the bidirectional fluid actuator.

The features and advantages of the present invention will become apparent in light of the detailed description of the invention provided below, and as illustrated in the accompanying drawings.

### BRIEF DESCRIPTION OF THE DRAWINGS

FIG. 1 illustrates a biologic fluid analysis device.

FIG. 2 is a diagrammatic planar view of a cartridge, including an external housing.

FIG. 3 is a diagrammatic sectional view of the cartridge embodiment, less the external housing.

FIG. 3A is a partial view of the cartridge illustrated in FIG. 3, having a metering aperture.

FIG. 4 is a diagrammatic sectional view of an embodiment of the present cartridge interface and the cartridge.

FIG. 5 is a schematic view of the present invention analysis system.

FIG. 6 is a diagrammatic view of the present invention sample motion system.

FIG. 7 is a diagrammatic view of a bidirectional fluid actuator embodiment.

FIG. 8 is a diagrammatic view of a bidirectional fluid actuator embodiment.

FIG. 9 is a schematic illustration of a bidirectional fluid actuator driver.

FIGS. 10A and 10B are diagrammatic illustrations of a sample bolus disposed in a channel with pressure forces acting on the bolus.

FIG. 11 is a diagrammatic sectional view of the cartridge embodiment, less the external housing, illustrating an embodiment of the bidirectional fluid actuator.

### DETAILED DESCRIPTION

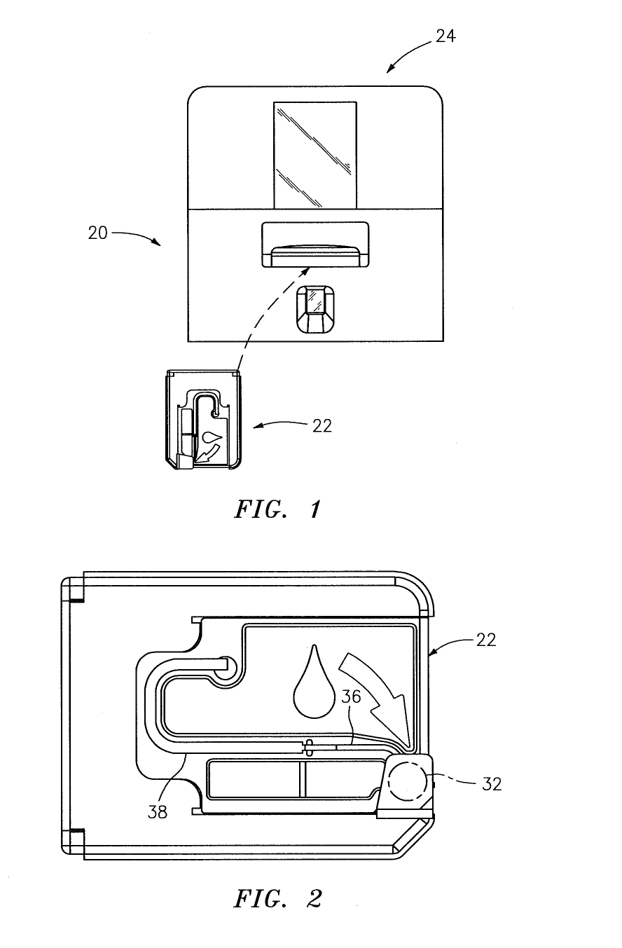

Referring to FIGS. 1-3, the present invention analysis system 20 includes a biologic fluid sample cartridge 22 and an automated analysis device 24 for analyzing biologic fluid samples such as whole blood. The automated analysis device 24 includes imaging hardware 26, a sample motion system 28, and a programmable analyzer 30 for controlling sample movement, imaging, and analyzing. The sample motion system 28 is operable to manipulate a fluid sample to ensure constituents within the sample are at least substantially uniformly distributed within the sample prior to analysis of the sample. The term “at least substantially uniformly distributed” is used herein to describe distribution of constituents and reagents within the sample that is adequate to provide acceptable accuracy for the analysis at hand; e.g., the sample is mixed to a degree such that sample sub-volumes removed from the sample for analysis will contain a representative distribution of the constituents within the sample, which representation is sufficiently accurate to avoid negatively affecting the accuracy of the analysis at hand A sample analysis cartridge 22 is diagrammatically described below to illustrate the utility of the present invention. The present system 20 is not limited to any particular cartridge 22 embodiment. An example of an acceptable cartridge 22 is described within U.S. patent application Ser. No. 61/287,955 filed Dec. 18, 2009, which is hereby incorporated by reference in its entirety. The present invention is not, however, limited to use with that particular cartridge 22.

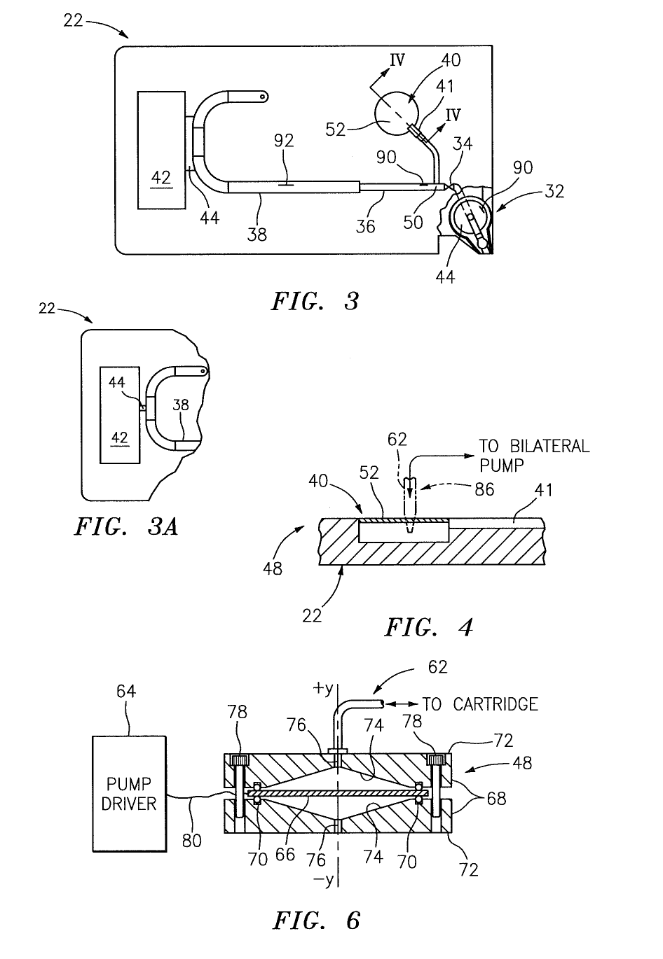

The exemplary cartridge 22 includes a fluid sample collection port 32, a valve 34, an initial channel 36, a secondary channel 38, a fluid actuator port 40, and an analysis chamber 42. The collection port 32 can be configured to accept a biologic fluid sample from a surface source (e.g., a finger prick), or from a sample container (e.g., deposited by needle, etc.). The initial channel 36 is in fluid communication with the collection port 32 and is sized so that sample deposited within the collection port 32 is drawn into the initial channel 36 by capillary forces. In some embodiments, the cartridge may include an overflow configured to accept and store sample in excess of that drawn into the initial channel The valve 34 is disposed in (or otherwise in communication with) the initial channel 36 proximate the collection port 32. The secondary channel 38 is in fluid communication with the initial channel 36, downstream of the initial channel 36. The intersection between the initial channel 36 and the secondary channel 38 is shaped such that fluid sample residing within the initial channel 36 will not be drawn by capillary force into the secondary channel 38. For example, in some embodiments the secondary channel 38 has a lengthwise uniform cross-sectional geometry that does not permit movement of the sample by capillary forces (e.g., see FIG. 3). In other embodiments, a portion of the secondary channel 38 located at the intersection with the initial channel 36 has the aforesaid cross-sectional geometry that prevents capillary movement of the sample. The secondary channel 38 is (or can be placed) in fluid communication with the analysis chamber 42. The analysis chamber 42 includes a pair of spaced apart panels (at least one of which is transparent) configured to receive a fluid sample there between for image analysis. The intersection between the secondary channel 38 and the analysis chamber 42 is such that fluid sample may be drawn “directly” or “indirectly” into communication with the analysis chamber 42 from the secondary channel 38 by capillary forces, or may be forced into the chamber 42; e.g., by external pressure. An example of structure that can “directly” draw the sample out of the secondary channel 38 is a metering channel that extends between the secondary channel 38 and the analysis chamber 42, and which metering channel is sized to draw fluid by capillary action (or allow fluid flow via external pressure). An example of structure that can “indirectly” draw sample out of the secondary channel 38 is an ante-chamber 46 disposed between and in fluid contact with both the secondary channel 38 and an edge of analysis chamber 42 (e.g., see FIG. 3). Fluid sample within the secondary channel 38 can, for example, be moved into the ante-chamber 46 via pressure from the sample motion system 28 or by gravity, etc. In some embodiments, the secondary channel 38 may terminate at the analysis chamber 42. Motive force from the sample motion system 28 can be used to expel sample from the secondary channel 38 and into the analysis chamber 42.

Referring to FIG. 4, the fluid actuator port 40 is configured to engage the sample motion system 28 and to permit a fluid motive force (e.g., positive air pressure and/or suction) to access the cartridge 22 to cause the movement of fluid sample within cartridge 22. The fluid actuator port 40 is in fluid communication with the initial channel 36; e.g., via channel 41 at a position 50 downstream of the valve 34. The valve 34 is operable to seal the collection port 32 from the fluid actuator port 40. An example of a fluid actuator port 40 is a cavity within the cartridge 22 covered by a cap 52 that includes a rupturable membrane. As will be discussed in greater detail below, in the cap 52 embodiment with a rupturable membrane, a probe 54 of the sample motion system 28 is configured to pierce the membrane and thereby create fluid communication between sample motion system 28 and the initial and secondary channels 36, 38. The present invention is not limited to this particular fluid actuator port 40 embodiment.

The cartridge materials that form the channels 36, 38 and the analysis chamber are preferably hydrophobic in nature. Examples of acceptable materials include:; polycarbonate (“PC”), polytetrafluoroethylene (“PTFE”), silicone, Tygon®, polypropylene, fluorinated ethylene polypylene (“FEP”), perfluouroalkoxy copolymer (“PFA”), cyclic olefin copolymer (“COC”), ethylene tetrafluoroethylene (ETFE), and polyvinylidene fluoride. In some instances, the fluid passages are coated to increase their hydrophobicity. An example of a hydrophobic material that can be applied as a coating is a FluoroPel™, which is marketed by Cytronix Corporation, or Beltsville, Md., U.S.A.

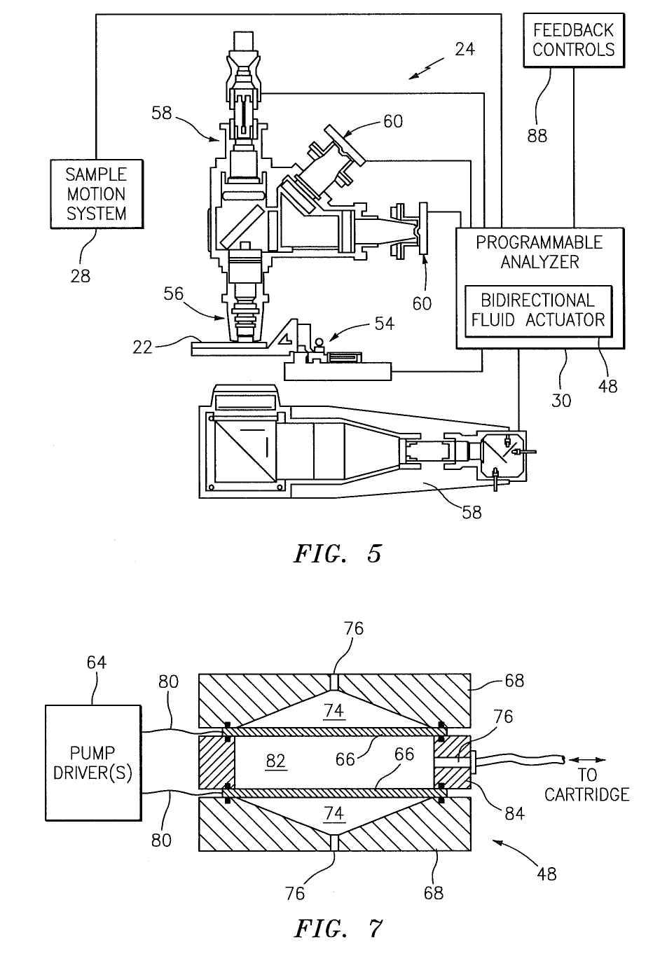

The present invention analysis device 24 is schematically shown in FIG. 5, depicting its imaging hardware 26, a cartridge holding and manipulating device 54, a sample objective lens 56, a plurality of sample illuminators 58, and an image dissector 60. One or both of the objective lens 56 and cartridge holding device 54 are movable toward and away from each other to change a relative focal position. The sample illuminators 58 illuminate the sample using light along predetermined wavelengths. Light transmitted through the sample, or fluoresced from the sample, is captured using the image dissector 60, and a signal representative of the captured light is sent to the programmable analyzer 30, where it is processed into an image. The imaging hardware 26 described in U.S. Pat. No. 6,866,823 and U.S. patent application Ser. No. 61/371,020 (each of which is hereby incorporated by reference in its entirety) are acceptable types of imaging hardware 26 for the present analysis device 24. The present invention is not limited to use with the aforesaid imaging hardware 26, however.

The programmable analyzer 30 includes a central processing unit (CPU) and is in communication with the cartridge holding and manipulating device 54, the sample illuminator 58, the image dissector 60, and the sample motion system 28. The CPU is adapted (e.g., programmed) to receive the signals and selectively perform the functions necessary to operate the cartridge holding and manipulating device 54, the sample illuminator 58, the image dissector 60, and the sample motion system 28. It should be noted that the functionality of the programmable analyzer 30 may be implemented using hardware, software, firmware, or a combination thereof. A person skilled in the art would be able to program the unit to perform the functionality described herein without undue experimentation.

Referring to FIGS. 4-6, the sample motion system 28 includes a bidirectional fluid actuator 48 and a cartridge interface 62. The bidirectional fluid actuator 48 (see FIG. 6) is operable to produce fluid motive forces that can move fluid sample within the cartridge channels 36,38 in either axial direction (i.e., back and forth) within a given channel, at a predetermined velocity. The bidirectional actuator 48 can be controlled to perform any one of: a) moving a sample bolus a given distance within the channels (e.g., between points “A” and “B”); b) cycling a sample bolus about a particular point at a predetermined amplitude (e.g., displacement stroke) and frequency (i.e., cycles per second); and c) moving (e.g., cycle) a sample bolus for a predetermined period of time; or combinations thereof The term “sample bolus” or “slug” is used herein to refer to a continuous body of fluid sample disposed within the cartridge; e.g., a continuous body of fluid sample disposed within one of the initial or secondary channels that fills a cross-section of channel, which cross-section is perpendicular to the axial length of the channel A bolus of the sample (e.g., the continuous body of fluid sample disposed within the initial channel), depending upon the particular geometric characteristics of the channel, can have an aspect ratio (i.e., the ratio of the axial length of the bolus to the hydrodynamic diameter of the channel) of about 0.5 to 10.0. A whole blood fluid sample admitted into an analysis cartridge such as that described above typically has a volume of about 10 μL to 40 μL. The sample volume analyzed in a particular analysis chamber 42 is likely substantially less (about 0.2-1.0 μL) than the typical size of a sample bolus.

An example of an acceptable bidirectional fluid actuator 48 is a piezoelectric bending disk type pump, utilized with a fluid actuator driver 64 for controlling the fluid actuator 48. A piezoelectric bending disk type pump is a favorable type bidirectional fluid actuator 48 because it provides characteristics such as a relatively fast response time, low hysteresis, low vibration, high linearity, high resolution (e.g., the pump can be controlled to accurately move relatively small volumes of fluid), and high reliability. In the embodiment shown in FIG. 6, a piezoelectric bending disk type pump embodiment of a bidirectional fluid actuator 48 is shown that includes a two-layer piezoelectric bending disk 66, a housing 68, and a seal arrangement 70. The two-layer piezoelectric bending disk 66 is configured to create bending deflection in two opposing directions (e.g., −y, +y). Examples of a two-layer piezoelectric bending disk 66 can be found in the T216-A4NO series offered by Piezo Systems, Inc., located in Cambridge, Massachusetts, U.S.A. The aforesaid two-layer disk 66 includes a pair of piezoceramic layers, separated from one another by a bond layer, x-poled for bending operation. A port 76 extends through each section of the housing 68 and provides a fluid passage into the cavity 74 associated with the housing section. In assembled form, the two-layer piezoelectric bending disk 66 is disposed between the two housing sections, with each cavity 74 aligned with the other. The seal arrangement 70 seals between the two-layer piezoelectric bending disk 66 and the housing sections; e.g., o-rings or elastomeric gaskets. Fasteners 78 extend through the clamp flanges 72 and hold the pump elements together. Electrical leads 80 in communication with the two layer piezo bending disk 66 provide electrical connection to the disk 66. In the embodiment shown in FIG. 6, the sections of the housing 68 are mirror images of each other. The bidirectional fluid actuator 48 is not limited to piezoelectric bending disk type pumps, and therefore not limited to the above described two-layer piezoelectric bending disk pump embodiment.

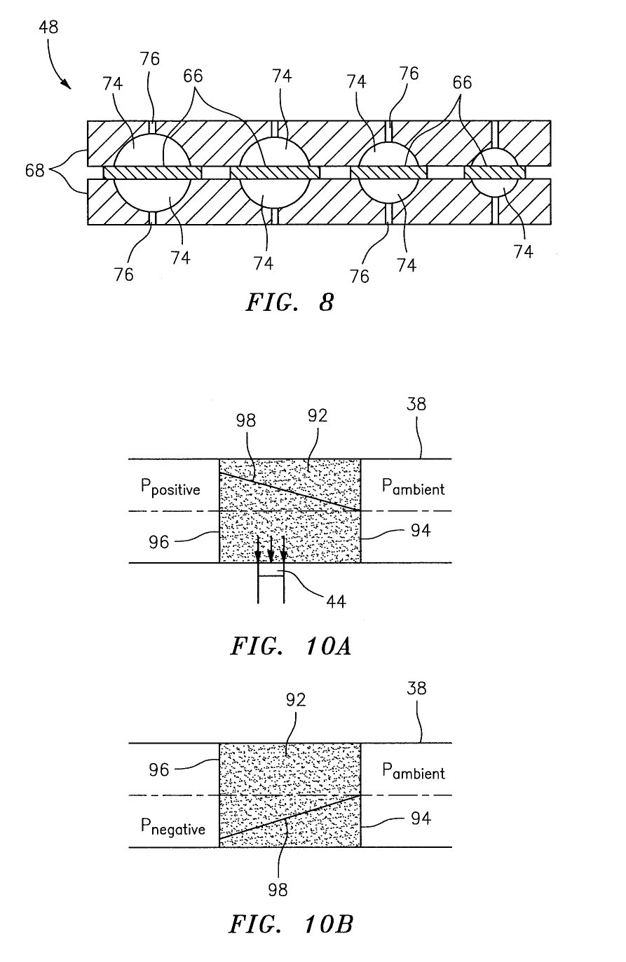

For example in an alternative embodiment as shown in FIG. 7, the bidirectional fluid actuator 48 is a piezoelectric bending disk type pump that includes a pair of piezo bending disks 66, each defining a portion of an internal pocket 82 within the pump. The housing 68 and sealing 70 of the fluid actuator 48 are similar to that described above. However, in this embodiment a spacer 84 is disposed between the disks 66 and a port 76 extends through the spacer 84, providing fluid communication with the internal pocket 82 formed between the disks 66. As shown in FIG. 7, the piezoelectric bending disks 66 are aligned with one another within the fluid actuator 48. In further alternative embodiments, the disks 66 are not aligned with one another and/or more than two disks 66 can be utilized. FIG. 8, for example, diagrammatically illustrates a piezoelectric bending disk type pump having more than two piezoelectric bending disks 66; e.g., four disks 66 disposed within a housing 68. Each of the disks 66 shown in this embodiment has different characteristics (e.g., size, resonant frequency, deflection, etc.) relative to the other disks 66. The different characteristics of the multiple disks 66 enable the fluid actuator 48 to selectively produce different positive and negative fluid displacements and/or at different frequencies. Each of the disks 66 may be selectively operated by itself, or in combination with one or more of the other disks 66 to produce the desired fluid actuator output.

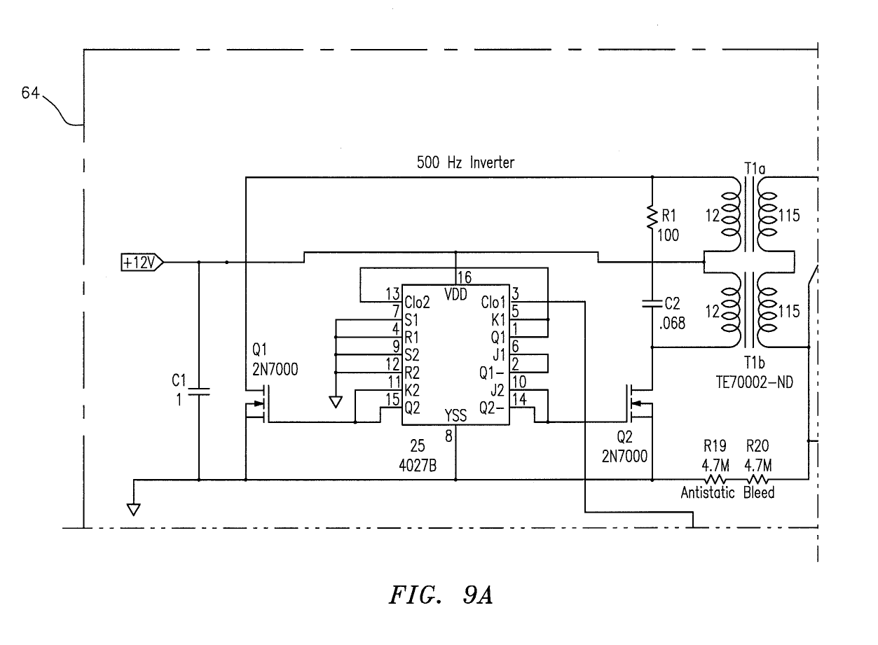

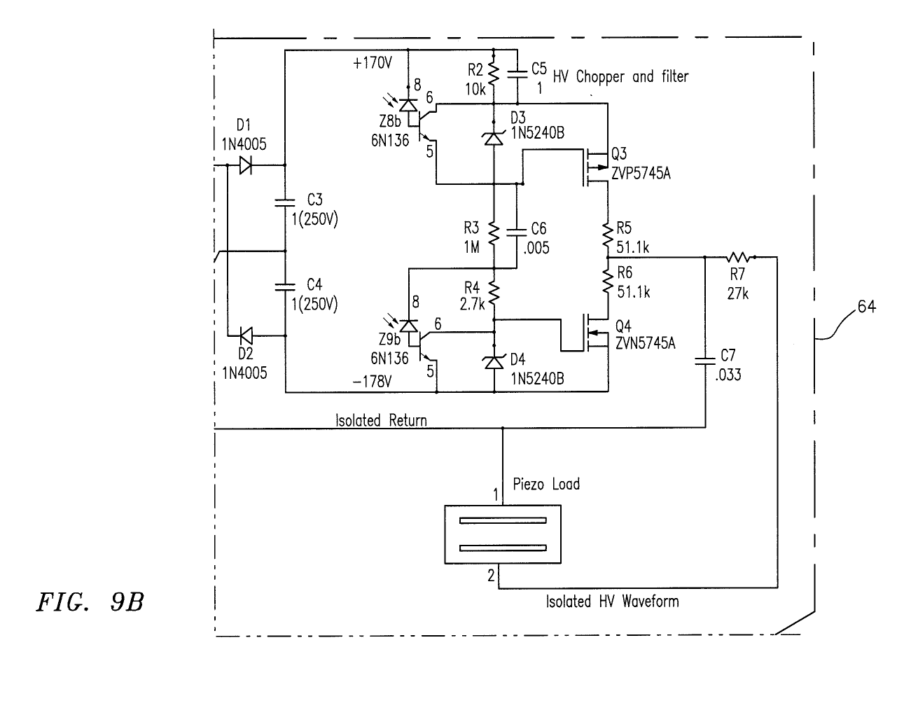

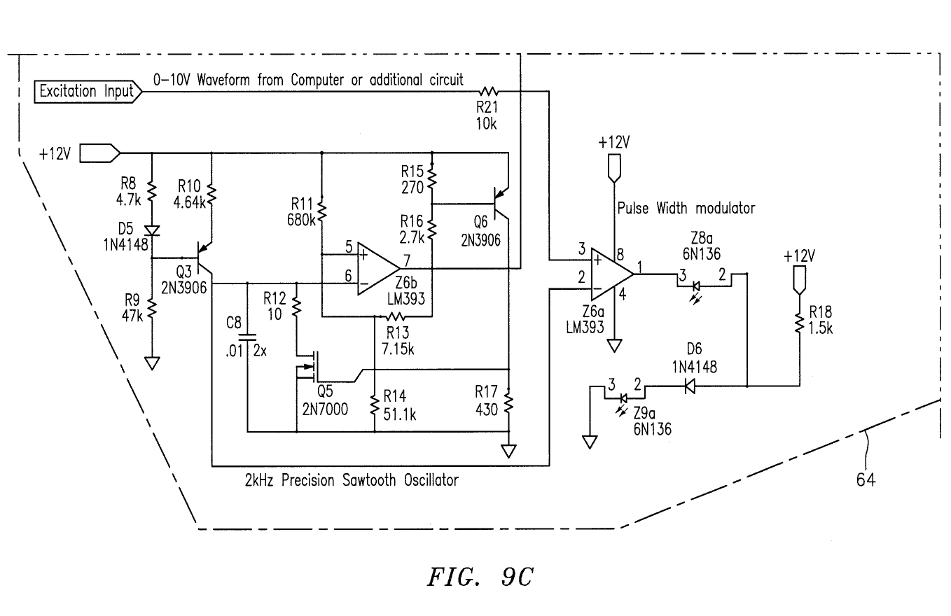

An example of an acceptable fluid actuator driver 64 is a schematically shown in FIG. 9 in communication with a piezoelectric two-layer bending disk type fluid actuator 48. The functionality of the fluid actuator driver 64 may be implemented using hardware, software, firmware, or a combination thereof. The fluid actuator driver 64 may be incorporated into the programmable analyzer 30, or may be a separate unit in communication with the programmable analyzer 30. The driver 64 includes a square wave inverter, a pulse width modulator, and a high voltage chopper and filter. The inverter includes a potted toroidal transformer and switching FETs, Q1 and Q2, and operates at frequency of about 500 Hz. The transformer includes secondary and primary windings. A relatively low voltage applied to the secondary windings produces a high voltage output from the primary windings. The pulse width modulator includes a precision sawtooth generator and a comparator, which operate together to form a precision pulse width modulator. An excitation input directly or indirectly from the programmable analyzer 30 is input into the pulse width modulator. The signal is subsequently passed through the inverter which changes the signal from a low voltage input into a higher voltage output. The HV chopper and filter conditions the higher voltage output into a form acceptable to drive a piezoelectric bending disk 66 within the bidirectional fluid actuator 48 in an accurate, repeatable manner As indicated above, the driver 64 schematically shown in FIG. 9 is an example of an acceptable driver for a piezoelectric bending disk type fluid actuator 48, and the present system 20 is not limited to use with this specific fluid actuator driver configuration. In those embodiments where more than one piezoelectric bending disk 66 is used, more than one fluid actuator driver 64 may be utilized.

In another embodiment, the bidirectional fluid actuator 48 is a current driven actuator in contrast to the voltage driven actuator described above. In this embodiment, a controlled current source is coupled with an electromagnetic actuator to drive a displacement structure similar to that utilized within a conventional audio speaker. Movement of the cone or other shaped displacement structure relative to a defined volume in fluid communication with the cartridge channels 36, 38 via the sample cartridge interface 62, causes a volume of air to be displaced, which volume of air can then be used to control the position of the sample bolus.

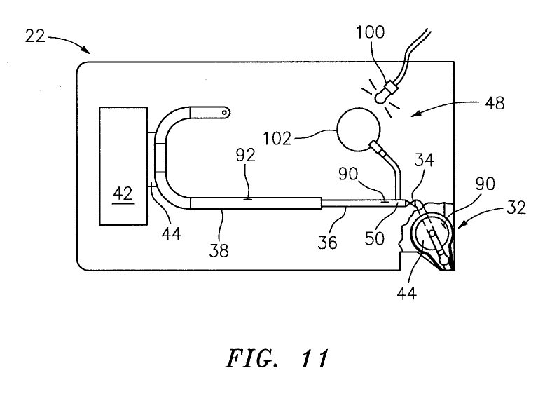

Referring to FIG. 11, in a further alternative embodiment, the sample motion system 28 (see FIG. 5) includes a bidirectional fluid actuator 48 that includes a selectively operable heat source 100 and an air chamber 102. In the embodiment shown in FIG. 11, the air chamber 102 is incorporated into the cartridge 22 in place of a fluid actuator port 40, and is in fluid communication with the initial channel 36 via a channel intersecting the initial channel downstream of the valve 34. In alternative embodiments, the air chamber 102 could be mounted independent of the cartridge 22. The air chamber 102 may be configured as, or configured to include, a I/R absorbing black body (e.g., a black panel, or a surface within the chamber covered in black/dark paint) to create thermal energy from an I/R light source. The air chamber 102 may also include open cell foam or other filler that would increase surface area to improve the thermal response. The heat source 100 is (e g , infrared light via an LED) is positioned remote from, but aimed at, the air chamber 102. When the selectively operable heat source 100 is turned on, air within the chamber 102 increases in temperature, expands, and increases the pressure within the chamber 102. As a result of the increased air pressure within the chamber 102, air is forced out of the air chamber 102 and into the initial channel 36, which in turn acts on the sample within the initial channel 36 and/or the sample within the secondary channel 38. The sample bolus 92 (see FIGS. 10A and 10B) within the initial channel 36 and/or the secondary channel 38 can be moved back and forth by cycling the heat source 100 (e.g., LED) on and off to change the pressure within the air chamber 102.

Referring to FIGS. 3 and 4, the sample cartridge interface 62 includes fluid passage between the bidirectional fluid actuator 48 and a probe 86 operable to engage the fluid actuator port 40 of the cartridge 22. The interface 62 creates fluid communication between a port element 76 (see FIG. 6) of the bidirectional fluid actuator 48 and the fluid actuator port 40 of the cartridge 22. If the fluid actuator port 40 has a cap 52 that includes a rupturable membrane, the probe 86 is operable to rupture the membrane and thereby provide fluid communication between the bidirectional fluid actuator 48 and cartridge fluid actuator port 40. The membrane, which is pierced by the probe 86, seals around the probe 86 to make the fluid path air tight. FIG. 4 diagrammatically illustrates this embodiment with a probe 86 shown in phantom. The present invention is not limited to the membrane/probe configuration, which is provided for illustration sake. Alternative interfaces between the bidirectional fluid actuator 48 and the cartridge 22 may be used.

In some embodiments, the analysis device 24 includes feedback controls 88 that are operable to detect the position of a sample bolus within the cartridge 22. The feedback controls 88 include sensors (e.g., electrical or optical sensors) operable to determine the presence of the sample at one or more particular locations within the cartridge 22. The feedback controls 88 provide the location information to the programmable analyzer 30, which in turn uses it to control the bidirectional fluid actuator 48 and/or other aspects of the device 24. In some embodiments, the feedback controls can be positioned and operated to sense if a predetermined volume of the analysis chamber 42 is filled. For example, a light source (e.g., a LED or a laser) in the infrared range (or any wavelength that is not significantly absorbed by fluid sample) can be used to illuminate the analysis chamber 42. Light incident to the sample reflects within the sample, traveling to the sample/air interface that forms the edge of the sample. The light impinging on the edge gives the edge a distinguishable characteristic (e.g., appear brighter than the sample body within the analysis chamber 42), which characteristic can be detected by an optical sensor. The advantages of detecting the sample edge in this manner include: a) both the light emitter and the detector can be located on the same side of the sample; b) the light emitter and detector do not need to be coupled or otherwise coordinated in their operation other than the emitter being on when the detector is detecting; and c) the light emitter can be positioned to produce incident light anywhere on the sample within the chamber and the edge will be detectable.

In the operation of the present system 20, a sample of biologic fluid (e.g., whole blood) is deposited within the collection port 32 of the cartridge 22, and is subsequently drawn into the initial channel 36 of the cartridge 22 by capillary action, gravity, or some combination of the both, where it may reside for a period of time (e.g., the time between subject collection and sample analysis). The sample will continue to be drawn into the initial channel 36 by capillary forces until the leading edge of the sample reaches the entrance to the secondary channel 38. In certain embodiments of the present cartridge 22, one or more reagents 90 (e.g., heparin, EDTA, dyes such as Acridine Orange, etc.) may be disposed within the initial channel 36 and/or in the collection port 32. In those embodiments, as the sample is deposited in the cartridge 22 and travels within the initial channel 36, the reagents 90 (e.g., anti-coagulants) are admixed with the sample. In those instances where the analysis of the sample is not performed immediately after sample collection, specific reagents (e.g., anticoagulants) can be admixing with the sample to maintain the sample in an acceptable state (e.g., uncoagulated) for analysis. For purposes of this disclosure, the term “reagent” is defined as including substances that interact with the sample, and dyes that add detectable coloration to the sample.

Prior to the analysis being performed on the sample, the cartridge 22 is inserted into the analysis device 24 for analysis of the sample, the sample cartridge interface probe 86 engages the fluid actuator port 40 of the cartridge 22, and the valve 34 within the cartridge 22 is actuated from an open position to a closed position to prevent fluid flow between the sample collection port 32 and initial channel 36. The specific order of these events can be arranged to suit the analysis at hand The manner in which the sample cartridge interface probe 86 engages the fluid actuator port 40 of the cartridge 22, and the manner in which the valve 34 is actuated from an open position to a closed, both can be selected to suit the analysis at hand and the level of automation desired. The fluid sample residing within the initial channel 36 between the valve 34 and the interface with the secondary channel 38 is referred to hereinafter as a bolus of sample or “sample bolus”.

In the case of a whole blood sample that was collected and not immediately analyzed, constituents within the blood sample, RBCs, WBCs, platelets, and plasma, can become stratified (or otherwise non-uniformly distributed) within the sample bolus residing within the initial channel 36 over time. In such cases, there is considerable advantage in manipulating the sample bolus prior to analysis so that the constituents become re-suspended in at least a substantially uniform distribution. In addition, in many applications there is also considerable advantage in uniformly mixing reagents with the sample bolus. To create a substantially uniform distribution of constituents and/or reagents within the sample bolus, the analysis device 24 provides a signal to the bidirectional fluid actuator 48 to provide fluid motive force adequate to act on the sample bolus residing within the initial channel 36; e.g., to move the sample bolus forwards, backwards, or cyclically within the initial channel 36. For example, if a sample bolus initially occupies a portion of the initial channel contiguous with the boundary between the initial and secondary channels, the bidirectional fluid actuator 48 can be used to draw the bolus a distance backward (i.e., away from the boundary). Subsequently the fluid actuator 48 can be used to move the bolus forward within the channel 36 at a predetermined axial velocity, and also may cycle the bolus about a particular axial location(s) within the initial channel (e.g., reagent locations, metering apertures 44, etc.) at a predetermined frequency, for a predetermined time. In all of these fluid sample motion scenarios, the feedback controls 88 can be coordinated with the operation of the bi-directional fluid actuator 48 to verify the position of the sample bolus.

In terms of a two-layer piezoelectric bending disk type embodiment of the bidirectional fluid actuator 48, the analysis device 24 provides a signal to the fluid actuator driver 64, which in turn sends a high-voltage signal to the piezoelectric bending disk type fluid actuator. The high voltage selectively applied to the piezoelectric disk 66 causes the disk 66 to deflect. Depending upon the desired action, the two-layer disk 66 may be operated to deflect and positively displace air and thereby move the sample bolus forward (i.e., in a direction toward the analysis chamber 42), or negatively displace air (i.e., create a suction) and thereby draw the sample bolus backward (i.e., in a direction away from the analysis chamber 42), or to cycle the sample bolus back and forth relative to a particular position. The cycle frequency and amplitude of the sample bolus can be controlled by the selection of the two-layer piezoelectric disk 66 and piezo driver 64.

In those bidirectional fluid actuator 48 embodiments that include two or more different piezoelectric bending disks 66, particular piezoelectric bending disks 66 can be selectively operated to accomplish a particular task alone or in combination with other piezoelectric bending disks 66. For example, a first disk 66 may provide a frequency response and displacement that works well to produce uniform re-suspension. A second disk 66 may provide a frequency response and displacement that works well to produce uniform reagent mixing. The disks 66 may also work in concert to produce relatively long positional displacements of the sample bolus within the cartridge 22.

Once the sample residing within the initial channel 36 (already mixed with an anticoagulant to some degree) is mixed sufficiently to create an at least substantially uniform distribution of constituents within the sample (and in some applications reagent mixing), the bidirectional fluid actuator 48 may be operated to move the sample bolus from the initial channel 36 to the secondary channel 38. Once the sample bolus is located within the secondary channel 38, the sample can be actuated to further mix the sample, and to prepare the sample for the analysis at hand For example, some analyses require adding more than one reagent to the sample in a specific sequential order. To accomplish the required mixing, the reagents may be deposited within the secondary channel in a sequential pattern from the initial channel interface to the analysis chamber interface. For example, in those analyses where it is necessary or desirable to have the sample admix with reagent “A” before mixing with reagent “B”, an appropriate amount of reagent “A” (e.g., an anticoagulant - EDTA) can be positioned in the channel 38 upstream of an appropriate amount of reagent “B”. The distance between the reagent “A” and reagent “B” may be sufficient for the reagent “A” to adequately mix with the sample prior to the introduction of reagent “B”. To facilitate mixing at either location, the sample bolus can be cycled at the location of the reagent “A”, and subsequently cycled at the position where reagent “B” is located. As indicated above, feedback controls 88 can be used to sense and control sample bolus positioning. The specific algorithm of sample movement and cycling is selected relative to the analysis at hand, the reagents to be mixed, etc. The present invention is not limited to any particular re-suspension/mixing algorithm.

The velocity at which the sample is moved axially within the channels 36,38 can have an effect on the amount of adsorption that occurs on the channel wall. In fluid channels having a hydrodynamic diameter in the range of 1.0 mm to 4.0 mm, it is our finding that a fluid sample velocity of not greater than about 20.0 mm/s is acceptable because it results in limited sample adsorption on the channel wall. A fluid sample velocity not greater then about 10.0 mm/s is preferred because it results in less adsorption. A fluid sample velocity within a range of between 1.0 mm/s and 5.0 mm/s is most preferred because it typically results in an inconsequential amount of adsorption.

The frequency and duration of the sample cycling can be chosen, for example, based on empirical data that indicates the sample will be substantially uniformly mixed as a result of such cycling; e.g., constituents substantially uniformly suspended within the sample bolus, and/or reagents substantially mixed with the sample bolus. In terms of a whole blood sample, empirical data indicates that cycling a sample bolus at a frequency in the range of about 5 Hz to 80 Hz within a cartridge channel can produce desirable mixing In those instances where a reagent is being mixed with a sample, it is often advantageous to use a cycle amplitude great enough such that the entire axial length of the sample bolus engages the reagent deposit. Higher cycling frequencies typically require less cycling duration to accomplish the desired mixing.

Sample cycling can also be used to facilitate transfer of sample out of a channel. As will be discussed below, some cartridge embodiments utilize a metering aperture 44 that provides a fluid passage between the secondary channel and the analysis chamber 42. The metering aperture 44 is sized (e.g., hydrodynamic diameter of about 0.3 mm to 0.9 mm) to “meter” out an analysis sample portion from the sample bolus for examination within the analysis chamber 42. At these dimensions, the resistance to the liquid flow is inversely proportional to the diameter of the channel A typical sized sample bolus is about 20 μL, and a typical analysis sample is about 0.2 μL to 0.4 μL. Because the sample bolus size is relatively small and the analysis sample substantially smaller, adsorption on the walls can significantly affect the constituency of an analysis sample drawn off via a metering aperture 44. To overcome that issue and to facilitate the transfer of sample to the metering aperture 44, the present invention is operable to use sample bolus cycling to create fluid pressure adequate to force sample into the metering aperture 44. The amount of pressure available varies as a function of the relative positions of the sample bolus and the metering aperture 44.

Referring to FIGS. 10A and 10B, a sample bolus 92 is diagrammatically shown disposed within a secondary channel 38. In FIG. 10A, the downstream edge 94 of the bolus 92 is at a pressure P_{ambient} and the upstream edge 96 is at Pₚₒₛᵢₜᵢᵥₑ where Pₚₒₛᵢₜᵢᵥₑ is greater than P_{ambient}. In this configuration, the sample bolus 92 is moving downstream propelled by the difference in pressure between Pₚₒₛᵢₜᵢᵥₑ and P_{ambient}. The difference in pressure exists along a gradient 98 extending between the downstream and upstream edges 94,96 of the sample bolus 92. As can be seen in FIG. 10A, the gradient 98 is such that the difference in pressure decreases in the direction from the upstream edge 96 to the downstream edge 94 of the bolus 92. Consequently, the pressure available to force sample from the bolus 92 into the metering aperture 44 (see FIG. 3A) is largest proximate the upstream edge 96 of the bolus 92. To take advantage of these characteristics, the bidirectional fluid actuator 48 can be controlled to align the upstream edge region of the sample bolus 92 with the metering aperture 44, and also to cycle the sample bolus 92 in a manner that maintains the higher pressure region of the sample bolus 92 aligned with the metering aperture 44. Conversely, in FIG. 10B, the downstream edge 94 of the bolus 92 is at a pressure P_{ambient} and the upstream edge is at P_{negative}, where P_{negative} is less than P_{ambient}. In this configuration, the sample bolus 92 is moving upstream propelled by the difference in pressure between and P_{ambient} and P_{negative}. Here again, the bidirectional fluid actuator 48 can be controlled to manipulate the position of the sample bolus 92 as desired.

The above paragraph discloses the advantages of locating and cycling a sample bolus at the location of a metering aperture 44 (FIG. 3A), and in particular the advantage of locating and cycling the sample bolus relative to the pressure gradient across the sample bolus. In an alternative embodiment, the same advantages can be provided without accurately knowing the position of the metering aperture 44. In this embodiment, the bidirectional fluid actuator 48 is operated to produce axial movement of the sample bolus in the direction toward the analysis chamber 42, and at the same time is controlled to produce cyclical movement of the sample bolus; i.e., the bolus oscillating at a predetermined frequency moves axial within the secondary channel 38 at a particular predetermined axial velocity. There is no need, consequently, to align the sample bolus with the metering aperture 44. At a particular point during the sample bolus movement, the sample bolus (including the high pressure region) will be aligned with the metering aperture 44 and the pressure gradient of the cycling bolus will facilitate the filling of the metering aperture 44. The cycling of the sample bolus can be created in a step-wise function as well. The described combination of bolus axial motion and bolus cycling can also be used to facilitate reagent mixing. By utilizing both movement techniques, the advantageous action of the cycling can be used, without the need for specific bolus location.

Once the re-suspension and/or reagent mixing is complete, the bidirectional fluid actuator 48 is operated to move the sample bolus to the portion of the secondary channel 38 in fluid communication with the analysis chamber 42. At that position, an amount of the sample bolus is drawn out of the secondary channel 38 where it can either be drawn or forced into the analysis chamber 42. Referring to FIG. 3, as indicated above in some embodiments of the cartridge 22 an ante-chamber 46 extends between the secondary channel 38 and the analysis chamber 42, which ante-chamber 46 is sized to receive a predetermined amount of the sample bolus. As soon as the sample within the ante-chamber 46 contacts the periphery of the analysis chamber 42, the sample is drawn into the analysis chamber 42 by capillary action. To control the amount of sample drawn into the analysis chamber 42, the ante-chamber 46 is limited in volume, and the bidirectional fluid actuator 48 is controlled to allow the sample bolus to reside in the aligned position only long enough for the ante-chamber 46 to fill up, which happens much more rapidly than the rate at which the sample is drawn out under capillary action. Once the ante-chamber 46 is filled, the bidirectional fluid actuator 48 is operated to move the sample bolus away from the ante-chamber 46. The determination of when the ante-chamber 46 is adequately filled can be made in a variety of different ways; e.g., using input from the feedback controls 88, sensing the ante-chamber 46, or timing data, etc. For those cartridge 22 embodiments that utilize a sample metering aperture 44 (FIG. 3A), the sample bolus is aligned with the sample metering aperture 44 and sample is either forced in using the sample motion system 28 or is drawn in by capillary forces. Once the metering aperture 44 is filled, the bidirectional fluid actuator 48 is operated to force the remaining sample bolus beyond the metering aperture 44. Once the bolus is downstream of the sample metering aperture 44, the bidirectional fluid actuator 48 can be used to produce sufficient pressure within the cartridge channels 36, 38 to force the sample out of the metering aperture and into contact with the analysis chamber 42. Alternatively, the metering aperture 44 can be positioned at the end of the secondary channel 38, and the analysis sample expelled from the aperture 44 using the sample motion system 28.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment(s) disclosed herein as the best mode contemplated for carrying out this invention.

What is claimed is:

1. A biologic fluid sample analysis system, comprising:
a sample cartridge having at least one channel, which channel is in fluid communication with an analysis chamber; and
an analysis device having imaging hardware, a programmable analyzer, and a sample motion system, which sample motion system includes a bidirectional fluid actuator operable to selectively axially move a bolus of fluid sample within the channel, and to cycle the bolus back and forth within the channel in a manner that at least substantially uniformly distributes constituents within the sample.

2. The system of claim 1, wherein the bidirectional fluid actuator includes at least one piezoelectric bending disk, and a piezoelectric disk driver in communication with a programmable analyzer disposed with the analysis device.

3. The system of claim 2, wherein the piezoelectric bending disk is a two layer piezo bending disk.

4. The sample of claim 1, wherein the sample motion system is adapted to cycle the sample bolus within the channel at a predetermined frequency.

5. The system of claim 4, wherein the sample motion system is further adapted to axially move the sample bolus at a predetermined velocity.

6. The system of claim 1, wherein the sample motion control system is one of a voltage driven system or a current driven system.

7. The system of claim 1, wherein the bidirectional fluid actuator is operable to move the sample bolus axially within the channel, and at the same time cycle the bolus back and forth within the channel, which movement at least substantially uniformly distributes constituents within the sample.

8. The system of claim 2, wherein the bidirectional fluid actuator includes a first piezoelectric bending disk and a second piezoelectric bending disk, wherein each piezoelectric bending disk has resonant frequency, size, and deflection type characteristics, and wherein a value of at least one of the resonant frequency, size, and deflection type characteristics of the first piezoelectric bending disk is different from the value of the same characteristic of the second piezoelectric bending disk.

9. The system of claim 1, wherein the bidirectional fluid actuator includes at least one source of thermal energy, and an air chamber, wherein the thermal energy source is selectively operable to increase or decrease fluid pressure within the air chamber, and is in communication with the programmable analyzer.

10. The system of claim 9, wherein the source of thermal energy is a light source.

11. A method of analyzing a biologic fluid sample, comprising the steps of:
providing a sample cartridge having at least one channel for fluid sample passage, which passage is in fluid communication with an analysis chamber;
providing an analysis device having imaging hardware, a programmable analyzer, and a sample motion system, which sample motion system includes a bidirectional fluid actuator operable to selectively move the bolus of fluid sample axially within the channel, and to cycle the sample bolus back and forth within the channel; and
cycling the sample bolus disposed within the channel at a predetermined frequency and for a predetermined period of time sufficient to at least substantially uniformly distribute constituents within the sample bolus, using the bidirectional fluid actuator.

12. The method of claim 11, wherein the sample cartridge includes a deposit of a reagent at a position within the channel, the method further comprising the step of:
cycling the sample bolus at the position within the channel where the reagent is deposited, at a predetermined frequency and time to mix the reagent with the sample bolus.

13. The method of claim 11, wherein the bidirectional fluid actuator includes at least one piezoelectric bending disk.

14. The method of claim 13, further comprising the step of controlling the at least one piezoelectric bending disk with a piezo disk driver operable to selectively drive the piezoelectric bending disk at one or both of a predetermined frequency and deflection.

15. The method of claim 11, wherein the bolus is cycled within the channel at a predetermined frequency.

16. The method of claim 11, wherein the sample bolus is moved axially within the channel at a predetermined velocity.

17. The method of claim 11, further comprising the step of moving the sample bolus axially within the channel, which axial movement occurs at the same time as the cycling of the bolus.

18. The method of claim 11, wherein the sample cartridge includes a deposition of a first reagent at a first position in the channel and a deposition of a second reagent at a second position in the channel, which second position is separated from the first position by an axial distance within the channel

19. The method of claim 18, wherein the sample bolus is cycled at the first position an amount sufficient to mix the sample bolus with the first reagent.

20. The method of claim 19, wherein the sample bolus is cycled at the second position an amount sufficient to mix the sample bolus with the second reagent.
